(19) United States
(12) Patent Application Publication
(10) Pub. No.: US 2012/0153845 A1
(43) Pub. Date: Jun. 21, 2012

(54) SOLID STATE LIGHTING CONTROL METHODS AND APPARATUSES FOR SERIES COMBINATIONS OF LIGHT EMITTING DIODES

(75) Inventor: Bruce R. Roberts, Mentor-on-the-Lake, OH (US)

(73) Assignee: GE Lighting Solutions, LLC

(21) Appl. No.: 12/971,252

(22) Filed: Dec. 17, 2010

(51) Int. Cl. H05B 37/02

(52) U.S. Cl. 315/185 R; 315/294

(57) ABSTRACT

A lighting apparatus comprises a lighting circuit and a control circuit. The lighting circuit includes a first sub-circuit comprising one or more solid state lighting (SSL) devices and having a diode electrical characteristic, and a second sub-circuit comprising one or more SSL devices and having a diode electrical characteristic. The first sub-circuit and the second sub-circuit are electrically connected in series with the cathode of the first sub-circuit and the anode of the second sub-circuit electrically connected at a first/second electrical connection. The control circuit includes an electrical drive voltage or current supply connected to drive the lighting circuit, and an adjustment current source connected with the first/second electrical connection to increase electrical current flowing in one of the first sub-circuit and the second sub-circuit without adjusting electrical current flowing in the other of the first sub-circuit and the second sub-circuit.

### BACKGROUND

The following relates to the illumination arts, lighting arts, solid-state lighting arts, and related arts.

Solid state lighting (SSL) devices such as light emitting diode (LED) devices, organic light emitting diode (OLED) devices, semiconductor laser diodes, and so forth have numerous advantages for lighting applications, including high efficiency, low power consumption, safe low temperature operation, high “solid state” reliability, and so forth. However, SSL devices are low voltage devices, and are relatively small devices such that a single SSL device is insufficient for some applications such as room lighting, outdoor lighting, or so forth. The low voltage operation requires substantial step-down in voltage in order to drive the device using commercially available “alternating current” voltage (VAC), such as 110 VAC in residential setting in the United States, and higher VAC in commercial settings and many other countries. The step-down in voltage typically entails resistive power dissipation which reduces efficiency and increase operational temperature. Another difficulty is that the electrical diode characteristic of most SSL devices requires rectification of the VAC.

A known approach for addressing this combination of concerns is the use of a series electrical configuration of the SSL devices. This has several benefits. The driving voltage for a series configuration of N devices having individual operating voltages of V_{ind} is NV_{ind}—thus, by employing a suitable number of SSL devices in series the operating voltage can be made closer to or even equal to the VAC. The series electrical configuration also readily accommodates a large number of SSL devices, thus facilitating multiple SSL device arrays for room lighting, outdoor lighting, or so forth. Yet another advantage is that typical SSL devices have light output intensity that correlates more closely with operating current than with operating voltage. In the series electrical configuration, all SSL devices are driven using a common current, which helps maintain uniformity of light intensity output for all SSL devices in the series. The use of a series electrical configuration does not eliminate the rectifier, but the higher operating voltage of the series electrical configuration can simplify the rectifier design.

In view of the foregoing benefits, the series electrical configuration is popular in commercial SSL devices. However, it has certain drawbacks. An open-circuit failure of any single SSL device results in failure of the entire series circuit. Moreover, if the SSL devices in the series electrical circuit are not all identical, differences between devices cannot be accommodated since they all operate on the single series current.

Approaches have been developed to alleviate these difficulties. One approach is the use of a series/parallel circuit in which parallel SSL device sub-circuits are interconnected in series. An open-circuit failure of one SSL device is thus bypassed by the SSL devices of the parallel sub-circuit. Moreover, resistances can be inserted into one or more of the parallel legs of the parallel sub-circuit to accommodate differences in optimal drive current for different SSL devices. For example, if each sub-circuit includes a parallel combination of a red-emitting LED device, a blue-emitting LED device, and a green-emitting LED device, then different resistances can be inserted into the “red”, “blue”, and “green” legs of the parallel sub-circuit to optimize drive currents.

While these approaches are beneficial, difficulties remain. The use of parallel sub-circuits does not enable closed-loop or feedback control of the current in different types of SSL devices in the series/parallel electrical circuit. Moreover, the resistances inserted into the various parallel legs increases resistive heating and lower efficiency.

An approach sometimes employed when there are differences between devices, e.g. a lamp having red, green, and blue emitting LED devices, is to employ a separate control circuit for each color. However, this approach substantially increases system cost and complexity.

### BRIEF SUMMARY

In some embodiments disclosed herein as illustrative examples, an apparatus comprises a lighting circuit and a control circuit. The lighting circuit includes a first sub-circuit comprising one or more solid state lighting (SSL) devices and having a diode electrical characteristic, and a second sub-circuit comprising one or more SSL devices and having a diode electrical characteristic, wherein the first sub-circuit and the second sub-circuit are electrically connected in series with the cathode of the first sub-circuit and the anode of the second sub-circuit electrically connected at a first/second electrical connection. The control circuit includes: an electrical drive voltage or current supply connected to drive the lighting circuit, and an adjustment current source connected with the first/second electrical connection to increase electrical current flowing in one of the first sub-circuit and the second sub-circuit without adjusting electrical current flowing in the other of the first sub-circuit and the second sub-circuit.

In some embodiments disclosed herein as illustrative examples, a method comprises: driving a series lighting circuit including a series interconnected plurality of solid state lighting (SSL) devices having diode electrical characteristics by applying an electrical drive current or voltage to the series lighting circuit; and injecting electrical current at an electrical connection between a cathode of a first SSL device and an anode of second SSL device of the series interconnected plurality of SSL devices. The injecting is selected from a group consisting of: (i) injecting positive electrical current at the electrical connection to increase light output of the second SSL device and any other SSL devices electrically downstream of the electrical connection without affecting light output of the first SSL device or any other SSL device electrically upstream of the electrical connection, and (ii) injecting negative electrical current at the electrical connection to increase light output of the first SSL device and any other SSL devices electrically upstream of the electrical connection without affecting light output of the second SSL device or any other SSL device electrically downstream of the electrical connection.

In some embodiments disclosed herein as illustrative examples, an apparatus comprises a lighting circuit and a control circuit. The lighting circuit includes an electrical series connection of sub-circuits, each sub-circuit comprising one or more solid state lighting (SSL) devices and having a diode electrical characteristic. The lighting circuit also has a diode characteristic. The control circuit includes: a drive voltage or current supply electrically connected to the lighting circuit to flow a common drive current through all sub-circuits of the electrical series connection of sub-circuits, and an adjustment current source connected to inject electrical current into an electrical connection between a cathode of a first sub-circuit and an anode of a second sub-circuit of the electrical series connection of sub-circuits. The injected electrical current is selected from a group consisting of: (i) a positive electrical current causing an increase in electrical current flowing through the second sub-circuit and any sub-circuits downstream of the second sub-circuit without changing electrical current flowing through the first sub-circuit or any sub-circuit upstream of the first sub-circuit, and (ii) a negative electrical current causing an increase in electrical current flowing through the first sub-circuit and any sub-circuits upstream of the first sub-circuit without changing electrical current flowing through the second sub-circuit or any sub-circuit downstream of the second sub-circuit.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a lighting circuit including solid state lighting (SSL) devices and including a control circuit as disclosed herein.

FIG. 2 diagrammatically shows diode electrical characteristics for the three different types of SSL devices of the lighting circuit of FIG. 1.

FIG. 3 diagrammatically illustrates a layout of the SSL devices of the three different types of FIGS. 1 and 2 which is suitable for blending light generated by the SSL devices of the three different types.

FIG. 4 diagrammatically shows a lighting circuit including SSL devices, some of which are in parallel-interconnected sub-circuits, and including a control circuit as disclosed herein.

FIG. 5 diagrammatically shows a lighting circuit including SSL devices of two different types and including a control circuit as disclosed herein.

FIG. 6 diagrammatically plots a suitable control approach in which the control circuit of FIG. 5 is used to compensate for different light intensity output degradation rates for the two different types of SSL devices.

FIG. 7 diagrammatically plots a suitable control approach in which the control circuit of FIG. 5 is used to maintain a desired intensity balance between light intensities generated by the SSL devices of the first type and of the second type.

FIG. 8 diagrammatically plots another suitable control approach in which the control circuit of FIG. 5 is used to maintain a desired intensity balance between light intensities generated by the SSL devices of the first type and of the second type.

### DETAILED DESCRIPTION OF PREFERRED EMBODIMENTS

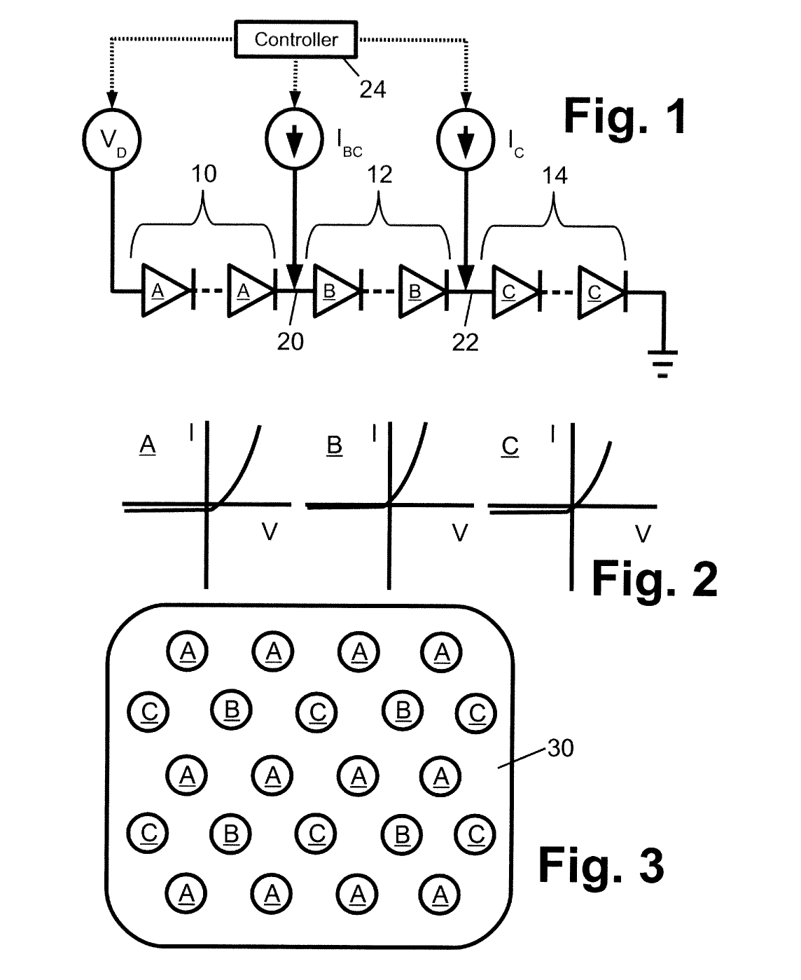

With reference to FIG. 1, an apparatus for generating light includes a lighting circuit and a control circuit. The illustrative lighting circuit includes three sub-circuits 10, 12, 14. The first sub-circuit 10 includes one or more SSL devices A of a first SSL device type connected in series. The second sub-circuit 12 includes one or more SSL devices B of a second SSL device type connected in series. The third sub-circuit 14 includes one or more SSL devices C of a third SSL device type connected in series. The three SSL device types are different from one another. The difference or differences may include, by way of illustrative example: different light spectra; different intensity-versus-electrical current characteristics; different intensity degradataion rates; various combinations thereof; or so forth.

As used herein, the term “spectra” is to be broadly construed as encompassing a monochromatic spectrum such as the line emission of a solid state laser device, as well as contiguous spectra with larger spectral full-width-at-half maximum (FWHM) values such as the narrow-band spectrum of a typical light emitting diode (LED) device, as well as non-contiguous spectra such as a multimodal solid state laser emitting a plurality of emission lines, and so forth. The term “light” as used herein is to be broadly construed as encompassing visible light, ultraviolet light, infrared light, and so forth.

The term “solid state lighting (SSL) device” is to be construed herein as encompassing SSL devices which have a diode electrical characteristic, such as by way of illustrative example light emitting diode (LED) devices, organic light emitting diode (OLED) devices, semiconductor laser diodes, and so forth. For illustrative purposes, LED devices A, B, C of the respective three different respective types are shown in the various illustrative embodiments. SSL devices as used herein do not encompass devices such as incandescent bulbs or fluorescent tubes which employ an evacuated space or a space filled with a controlled ambient.

With reference to FIG. 2, the term “diode electrical characteristic” denotes an electrical characteristic in which (i) the SSL device flows current and consequently emits light when biased at DC in one polarity (referred to herein as the positive polarity) and (ii) the SSL device flows little or no current and consequently emits little or no light when biased at DC in the opposite (i.e., negative) polarity. FIG. 2 shows diagrammatic diode electrical characteristics as current-voltage plots for LED devices A, B, C of the respective three different respective types.

With continuing reference to FIG. 1, the series LED device strings of the first, second, and third sub-circuits 10, 12, 14 are diagrammatically indicated by showing first and last LED devices and a dotted series connection line therebetween, which is intended to denote optional additional LED devices in the series string. (Moreover, although not indicated by diagrammatic FIG. 1 a given sub-circuit may include as few as a single LED device). The LED device or devices of each sub-circuit 10, 12, 14 is/are arranged such that the sub-circuit has a diode electrical characteristic. In sub-circuit 10, this is accomplished by connecting the cathode of each LED device A to the anode of the next LED device A in the series. Sub-circuits 12, 14 are analogously constructed. Because each sub-circuit 10, 12, 14 has a diode electrical characteristic, each sub-circuit 10, 12, 14 also has an anode and a cathode. The lighting circuit is formed by connecting these sub-circuits 10, 12, 14 in series: the cathode of the first sub-circuit 10 is connected with the anode of the second sub-circuit 12 at a first/second electrical connection 20; and the cathode of the second sub-circuit 12 is connected with the anode of the third sub-circuit 14 at a second/third electrical connection 22.

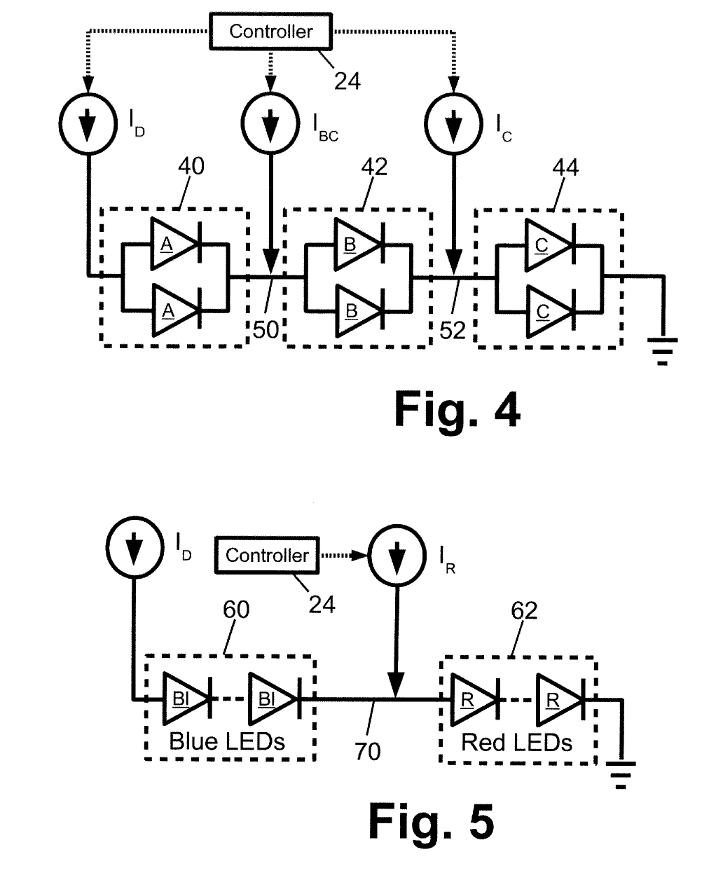

The control circuit includes an electrical drive voltage supply V_{D} connected to drive the lighting circuit. In the embodiment of FIG. 1 the electrical drive voltage supply V_{D} is connected to the anode of the sub-circuit 10 which is furthest upstream (in the electrical sense) in the lighting circuit, and the cathode of the sub-circuit 14 which is furthest downstream is connected to electrical ground. Alternatively, the anode of the lighting circuit may be grounded and the cathode connected to a negative voltage supply, or a differential or floating electrical drive voltage supply may be used. Additionally, an electrical current supply may be used to drive the lighting circuit (not shown in FIG. 1, but see current supply I_{D} in FIGS. 4 and 5). The electrical drive voltage supply V_{D} flows the same electrical current through all three sub-circuits 10, 12, 14. Since the sub-circuits 10, 12, 14 are series connections of LED devices A, B, C, it follows that the electrical drive voltage supply V_{D} flows the same electrical current through all LED devices A, B, C.

Relying upon the electrical drive voltage supply V_{D} (or, alternatively, the electrical drive current supply I_{D}) alone, there is no way to adjust the relative currents flowing through the three sub-circuits 10, 12, 14 (or, equivalently for the lighting circuit of FIG. 1, there is no way to adjust the relative currents flowing through the three types of LED devices A, B, C).

With continuing reference to FIG. 1, to provide individualized control of the sub-circuits 10, 12, 14, the control circuit further includes an adjustment current source I_{BC} connected with the first/second electrical connection 20, and an adjustment current source I_{C} connected with the second/third electrical connection 22. These adjustment current sources are operated by a controller 24 to provide individualized control as follows. When the adjustment current source I_{C} flows a positive electrical current into the second/third electrical connection 22, the current cannot flow upstream (in the electrical sense) because of the diode electrical characteristics of the upstream sub-circuits 10,12 of the lighting circuit. The injected positive electrical current can only flow downstream, through the third sub-circuit 14. Accordingly, using the adjustment current source I_{C} to inject a positive electrical current into the second/third electrical connection 22 adjusts (and more particularly increases) the electrical current flowing through the downstream third sub-circuit 14, but does not adjust the electrical current flowing through the upstream sub-circuits 10, 12. For LED devices (and, more generally, for most SSL devices) the light output intensity increases monotonically with increasing current flow—accordingly, the adjustment current source I_{C} can be used to inject a positive electrical current into the second/third electrical connection 22 in order to increase the light output of the third sub-circuit 14 comprising one or more LED devices C without affecting the light output of the first and second sub-circuits 10, 12 comprising LED devices A, B.

When the adjustment current source I_{BC} flows a positive electrical current into the first/second electrical connection 20, the current cannot flow upstream into the first sub-circuit 10 because of the diode electrical characteristics of the sub-circuit 10. The injected positive electrical current can only flow downstream, through the second and third sub-circuits 12, 14. Accordingly, using the current source I_{BC} to inject a positive electrical current into the first/second electrical connection 20 adjusts (and more particularly increases) the electrical current flowing through the downstream second and third sub-circuits 12, 14, but does not adjust the electrical current flowing through the upstream sub-circuit 10. Thus, the adjustment current source I_{BC} can be used to inject a positive electrical current into the first/second electrical connection 20 in order to increase the light output of the second and third sub-circuits 12, 14 comprising LED devices B, C without affecting the light output of the first sub-circuit 10 comprising LED devices A.

In some embodiments, the adjustment current sources I_{BC}, I_{C} can also flow negative electrical current into the respective electrical connection 20, 22. When the adjustment current source I_{BC} flows a negative electrical current into the first/second electrical connection 20, the current cannot flow through the downstream sub-circuits 10,12 of the lighting circuit due to the polarity of their diode electrical characteristics. Rather, the injected negative electrical current can only flow through the first sub-circuit 10. Accordingly, using the adjustment current source I_{BC} to inject a negative electrical current into the first/second electrical connection 20 adjusts (and more particularly increases) the electrical current flowing through the upstream first sub-circuit 10, but does not adjust the electrical current flowing through the downstream second and third sub-circuits 12, 14. This results in an increase in the light output of the first sub-circuit 10 comprising LED devices A without affecting the light output of the second and third sub-circuits 12, 14 comprising LED devices B, C.

By analogous analysis, when the adjustment current source I_{C} flows a negative electrical current into the second/third electrical connection 20, this results in an increase in the light output of the first and second sub-circuits 10, 12 comprising LED devices A, B without affecting the light output of the sub-circuit 14 comprising LED devices C.

The adjustment current source I_{BC} operating with a negative electrical current can individually increase output of the LED devices A without affecting the remaining LED devices B, C. Similarly, the adjustment current source I_{C} operating with a positive electrical current can individually increase output of the LED devices C without affecting the remaining LED devices A. B.

In the control circuit of FIG. 1, there is no single adjustment current source acting to individually increase output of the LED devices B without affecting the LED devices A, C. However, if adjustment current source I_{BC} is operated with a positive current and adjustment current source I_{C} is operated with a negative current then the output of the LED devices B will typically increase by an amount greater than the increase of the output of the LED devices A, C. If the controller 24 concurrently operates to reduce the drive voltage provided by the electrical drive voltage supply V_{D} (or, alternatively, the electrical drive current supply I_{D}) so as to compensate for the increase in output of the LED devices A, C, then individualized increase of the output of the LED devices B can be achieved without affecting the LED devices A, C.

Similarly, it is possible to implement a decrease in the output of a selected one or two of the three sub-circuits 10, 12, 14, by lowering the electrical drive voltage supply V_{D} (or, alternatively, the electrical drive current supply I_{D}) to lower the outputs of all three three sub-circuits 10, 12, 14 and employing the adjustment current source I_{BC} and/or adjustment current source I_{C} to compensate for the lower output where desired.

With reference to FIG. 3, it is noted that the electrical series arrangement of the LED devices A, B, C does not imply anything about the spatial arrangement of the LED devices A, B, C. For example, FIG. 3 shows a lighting device having a substrate 30 (which may, for example, be a circuit board) on which twelve LED devices A are disposed, four LED devices B are disposed, and six LED devices C are disposed. Electrically, the twelve LED devices A are connected in series to form the first sub-circuit 10 of FIG. 1; the four LED devices B are connected in series to form the second sub-circuit 12 of FIG. 1; and the six LED devices C are connected in series to form the third sub-circuit 14 of FIG. 1. The electrical interconnections may, for example, be embodied by electrically conductive traces of the substrate 30 if the substrate 30 comprises a circuit board. By spatially intermingling the LED devices A, B, C of the three different types as shown in FIG. 3, the lighting circuit generates a composite spectrum comprising co mixture of the first, second, and third spectra of the three respective LED device types. For example, if these spectra are red, green, and blue spectra the composite spectrum may be white light. The color temperature, color rendering index (CRI), or other characteristics of the white light may be adjusted using one or both of the adjustment current sources I_{BC}, I_{C} to adjust the balance between the constituent red, green, and blue spectra.

With reference to FIG. 4, it is noted that the sub-circuits can have topologies other than a single series interconnection topology. By way of illustrative example, the apparatus of FIG. 4 employs the same control circuit as the apparatus of FIG. 1, except that for illustrative purposes the electrical drive voltage supply V_{D} of the apparatus of FIG. 1 is replaced by an electrical drive current supply I_{D} connected to drive the lighting circuit. However, the series-interconnected sub-circuits 10, 12, 14 are replaced by respective parallel-interconnected sub-circuits 40, 42, 44 in the embodiment of FIG. 4. Each of the sub-circuits 40, 42, 44 have a diode electrical characteristic, and the parallel-interconnected sub-circuits 40, 42, 44 are connected in series via: first/second electrical connection 50 that connects the cathode of the first sub-circuit 40 and the anode of the second sub-circuit 42, and second/third electrical connection 52 that connects the cathode of the second sub-circuit 42 and the anode of the third sub-circuit 44. The sub-circuits can employ still other topologies, such as series/parallel topologies, and can include additional components such as resistors, electrostatic discharge (ESD) protection devices, and so forth. The sub-circuit topology should be configured such that the overall sub-circuit has a diode electrical characteristic when driven by definable anode and cathode terminals.

While the apparatuses of FIGS. 1 and 4 each include three sub-circuits arranged electrically in series, the number of sub-circuits can be as few as two (see, e.g., FIG. 5). On the other hand, there is no upper limit to the number of sub-circuits that can be included. Without loss of generality, the electrical series connection of sub-circuits is suitably considered to comprise an electrical series connection of N sub-circuits where N is an integer greater than or equal to two, and the adjustment current source suitably comprises (N−1) adjustment current sources connected to inject (N−1) electrical currents into respective (N−1) cathode/anode electrical connections of the electrical series connection of N sub-circuits.

The disclosed control approaches are suitable for diverse applications. Two illustrative applications are described with reference to FIGS. 5-8.

With reference to FIG. 5, the illustrative applications are described with reference to the apparatus shown in FIG. 5, which includes a lighting device with two sub-circuits 60, 62 in series. The sub-circuit 60 comprises blue LED devices B1, and hence is sometimes referred to herein as the blue sub-circuit 60. The sub-circuit 62 comprises red LED devices R, and hence is sometimes referred to herein as the red sub-circuit 62. The blue and red LED devices B1, R are arranged in an intermixed spatial arrangement on a circuit board or other lamp face (spatial arrangement not illustrated) such that the lighting apparatus generates a composite spectrum comprising a mixture of the blue light generated by the blue LED devices B1 of the first sub-circuit 60 and red light generated by the red LED devices R of the second sub-circuit 62. For a suitable intensity ratio, the mixture of blue and red light can produce white light. By increasing the blue/red ratio the white light can be made “cooler”, while decreasing the blue/red ratio produces “warmer” white light.

The two sub-circuits 60, 62 each have a diode electrical characteristic, and are connected in series via a first/second electrical connection 70 that connects the cathode of the first sub-circuit 60 and the anode of the second sub-circuit 62. Since there are only N=2 sub-circuits 60, 62, the control circuit suitably includes only N−1=1 adjustment current source I_{R}. The control circuit of the apparatus of FIG. 5 includes the electrical drive current supply I_{D}, which in the control circuit of FIG. 5 is not under control of the controller 24. (By way of illustrative example, the electrical drive current supply I_{D} may be configured to deliver a fixed drive current level that cannot be adjusted by the controller 24). In the apparatus of FIG. 5, a positive electrical current injected by the adjustment current source I_{R} into the first/second electrical connection 70 causes the current through (and hence light output from) the red sub-circuit 62 to increase without affecting the current or light output of the blue sub-circuit 60. On the other hand, a negative electrical current injected by the adjustment current source I_{R} into the first/second electrical connection 70 causes the current through (and hence light output from) the blue sub-circuit 60 to increase without affecting the current or light output of the red sub-circuit 62.

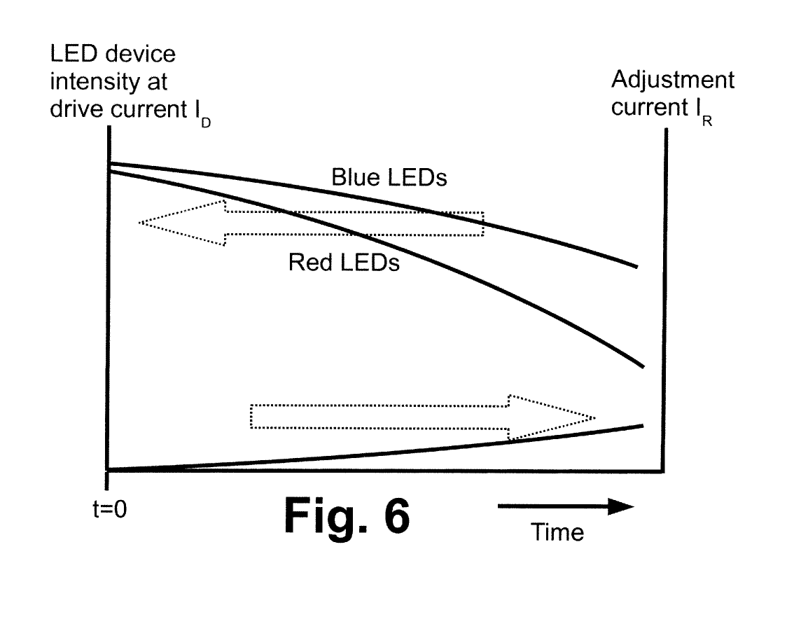

With reference to FIG. 6, in one application the red LED devices R have a higher intensity degradation rate than the blue LED devices B1. That is, the reduction (i.e., degradation) of the red light intensity for a given drive current level decreases over time at a relatively faster rate as compared with the reduction (i.e., degradation) of the blue light intensity for a given drive current level. The effect over time is for the white light to shift toward a cooler white. To compensate for this effect, the control circuit is suitably configured to compensate for the different intensity degradation rates by increasing over time electrical current flowing in the red sub-circuit 62 using the adjustment current source I_{R}. The precise shape of the injected current level as a function of time is suitably calibrated empirically using accelerated life testing (ALT) or other characterization of the intensity degradation rates.

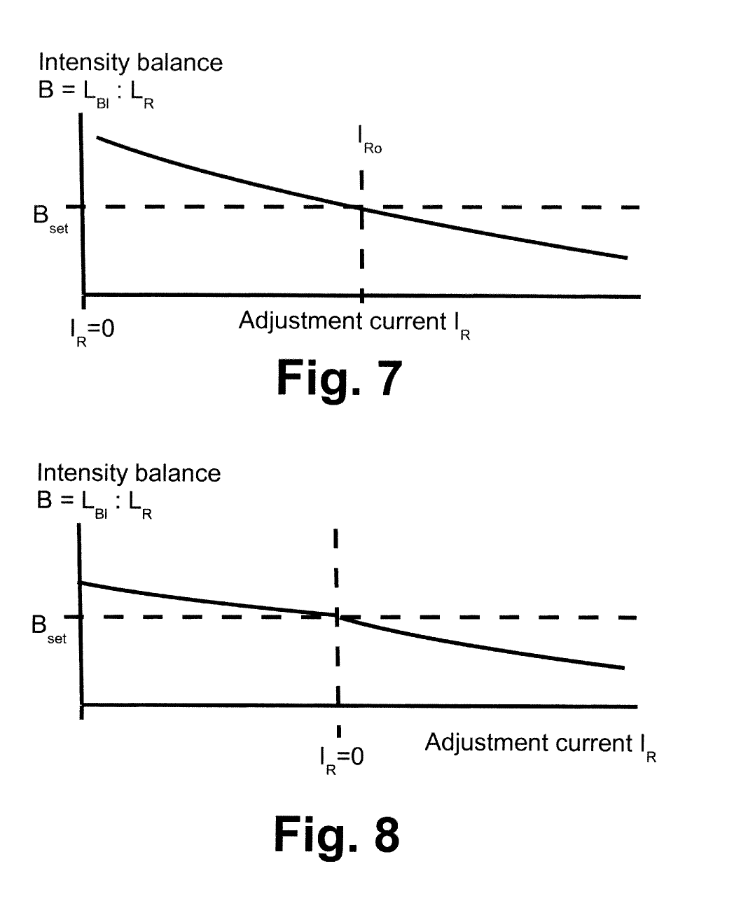

With reference to FIG. 7, in another application the blue/red light ratio is adjusted using the adjustment current source I_{R}. FIG. 7 shows one approach, in which the desired intensity balance Bₛₑₜ is designed to be obtained with a current level I_{Ro} injected by the adjustment current source I_{R}. Suitable wavelength-selective photodetectors or another feedback source (not shown) provide feedback for adjusting the adjustment current source I_{R} to maintain the intensity balance at or close to Bₛₑₜ. By using the finite positive design current I_{Ro}, any corrections are likely involve adjustments of this positive current that remain close to I_{Ro}. Thus, it is unlikely that injection of a negative current will be needed to maintain the desired intensity balance Bₛₑₜ. In some such embodiments, the adjustment current source I_{R} is not designed to inject a negative current, which may simplify design of the adjustment current source I_{R}.

With reference to FIG. 8, another approach for maintaining the blue/red light ratio at Bₛₑₜ is shown. In this approach, the desired intensity balance Bₛₑₜ is designed to be obtained with no injected current. In this approach the adjustment current source I_{R} must be capable of injecting either positive or negative current. On the other hand, an advantage of the design of FIG. 8 is that the injected current (whether positive or negative) is likely to be quite small.

The disclosed control approaches are suitable for many applications, including applications in which the intensity control may entail large changes in current flow. However, it will be appreciated that the disclosed control approaches are particularly well-suited for intensity control involving small adjustments, such as in the illustrative applications of correcting for intensity degradation over time or adjusting the coolness or warmth of a white light source. In applications in which adjustments are expected to be small, the adjustment current source or sources can be lower-power devices which reduces cost and complexity.

In the illustrative embodiments, the drive and adjustment electrical currents are assumed to be dc currents. However, the disclosed control approaches are also suitably applied for other types of control currents, such as pulsed control currents. Moreover, the disclosed control approaches are combinable with other control approaches, such as pulse width modulation (PWM). For example, in one PWM approach that also integrates the disclosed approaches, the drive and control currents are in phase and have the same pulse widths. In this case, the adjustment current source superimposes a pulse amplitude modulation (PAM) component onto the PWM drive current.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. An apparatus comprising:
a lighting circuit including:
a first sub-circuit comprising one or more solid state lighting (SSL) devices and having a diode electrical characteristic, and
a second sub-circuit comprising one or more SSL devices and having a diode electrical characteristic,
wherein the first sub-circuit and the second sub-circuit are electrically connected in series with the cathode of the first sub-circuit and the anode of the second sub-circuit electrically connected at a first/second electrical connection; and
a control circuit including:
an electrical drive voltage or current supply connected to drive the lighting circuit, and
an adjustment current source connected with the first/second electrical connection to increase electrical current flowing in one of the first sub-circuit and the second sub-circuit without adjusting electrical current flowing in the other of the first sub-circuit and the second sub-circuit.

2. The apparatus as set forth in claim 1, wherein the adjustment current source is configured to inject one of:
a positive electrical current into the first/second electrical connection to increase electrical current flowing in the second sub-circuit without adjusting electrical current flowing in the first sub-circuit, and
a negative electrical current into the first/second electrical connection to increase electrical current flowing in the first sub-circuit without adjusting electrical current flowing in the second sub-circuit.

3. The apparatus as set forth in claim 1, wherein:
the first sub-circuit comprises a plurality of first light emitting diode (LED) devices electrically connected in series; and
the second sub-circuit comprises a plurality of second light emitting diode (LED) devices electrically connected in series;
the first LED devices differing from the second LED devices by at least one of light Output spectrum and light output intensity versus electrical current characteristic.

4. The apparatus as set forth in claim 1, wherein at least one of the first sub-circuit and the second sub-circuit includes a plurality of SSL devices electrically connected in parallel.

5. The apparatus as set forth in claim 1, wherein:
the first sub-circuit comprises one or more light emitting diode (LED) devices of a first LED device type; and
the second sub-circuit comprises one or more LED devices of a second LED device type different from the first LED device type.

6. The apparatus as set forth in claim 5, wherein:
the first LED device type and the second LED device type have different intensity degradation rates; and
the control circuit is configured to compensate for the different intensity degradation rates by increasing over time electrical current flowing in the sub-circuit comprising LED devices of the LED device type having the higher intensity degradation rate.

7. The apparatus as set forth in claim 5, wherein:
the first LED device type generates light of a first spectrum;
the second LED device type generates light of a second spectrum different from the first spectrum;
in the lighting circuit, the LED devices of the first LED device type and the LED devices of the second LED device type are spatially arranged such that the lighting circuit generates a composite spectrum comprising a mixture of the first and second spectra; and
the control circuit is configured to operate the lighting circuit to generate light with a desired composite spectrum using the adjustment current source.

8. The apparatus as set forth in claim 1, wherein:
the lighting circuit further comprises a third sub-circuit comprising one or more SSL devices and having a diode electrical characteristic, wherein the first, second, and third sub-circuits are electrically connected in series with the cathode of the second sub-circuit and the anode of the third sub-circuit being electrically connected at a second/third electrical connection;
the adjustment current source connected with the first/second electrical connection increases electrical current flowing in one of the first sub-circuit and the series interconnection of the second and third sub-circuits without adjusting electrical current flowing in the other of the first sub-circuit and the series interconnection of the second and third sub-circuits; and
the control circuit further comprises an adjustment current source connected with the second/third electrical connection to increase electrical current flowing in one of the series interconnection of the first and second sub-circuits and the third sub-circuit without adjusting electrical current flowing in the other of the series interconnection of the first and second sub-circuits and the third sub-circuit.

9. The apparatus as set forth in claim 1, wherein the control circuit is configured to concurrently adjust both the electrical drive voltage or current supply connected to drive the lighting circuit and the adjustment current source to concurrently increase electrical current flowing in one of the first sub-circuit and the second sub-circuit and reduce electrical current flowing in the other of the first sub-circuit and the second sub-circuit.

10. A method comprising:
driving a series lighting circuit including a series-interconnected plurality of solid state lighting (SSL) devices having diode electrical characteristics by applying an electrical drive current or voltage to the series lighting circuit; and
injecting electrical current at an electrical connection between a cathode of a first SSL device and an anode of second SSL device of the series-interconnected plurality of SSL devices wherein the injecting is selected from a group consisting of
(i) injecting positive electrical current at the electrical connection to increase light output of the second SSL device and any other SSL devices electrically downstream of the electrical connection without affecting light output of the first SSL device or any other SSL device electrically upstream of the electrical connection, and
(ii) injecting negative electrical current at the electrical connection to increase light output of the first SSL device and any other SSL devices electrically upstream of the electrical connection without affecting light output of the second SSL device or any other SSL device electrically downstream of the electrical connection.

11. The method of claim 10, further comprising one of:
increasing the positive electrical current over time to compensate for a reduction over time in light output of the second SSL device and any other SSL devices electrically downstream of the electrical connection, and
increasing the negative electrical current over time to compensate for a reduction over time in light output of the first SSL device and any other SSL devices electrically upstream of the electrical connection.

12. The method of claim 10, further comprising:
adjusting the injecting to control a ratio between (i) light output of the first SSL device and any other SSL device electrically upstream of the electrical connection and (ii) light output of the second SSL device and any other SSL device electrically downstream of the electrical connection.

13. The method of claim 10, further comprising:
adjusting the driving concurrently with the injecting to maintain a constant light intensity output of the lighting circuit.

14. An apparatus comprising:
a lighting circuit including an electrical series connection of sub-circuits, each sub-circuit comprising one or more solid state lighting (SSL) devices and having a diode electrical characteristic, the lighting circuit also having a diode characteristic; and
a control circuit including:
a drive voltage or current supply electrically connected to the lighting circuit to flow a common drive current through all sub-circuits of the electrical series connection of sub-circuits, and
an adjustment current source connected to inject electrical current into an electrical connection between a cathode of a first sub-circuit and an anode of a second sub-circuit of the electrical series connection of sub-circuits, the injected electrical current being selected from a group consisting of:
(i) a positive electrical current causing an increase in electrical current flowing through the second sub-circuit and any sub-circuits downstream of the second sub-circuit without changing electrical current flowing through the first sub-circuit or any sub-circuit upstream of the first sub-circuit, and
(ii) a negative electrical current causing an increase in electrical current flowing through the first sub-circuit and any sub-circuits upstream of the first sub-circuit without changing electrical current flowing through the second sub-circuit or any sub-circuit downstream of the second sub-circuit.

15. The apparatus as set forth in claim 14, wherein each sub-circuit of the electrical series connection of sub-circuits includes at least one of (i) a plurality of SSL devices electrically connected in series and (ii) a plurality of SSL devices electrically connected in parallel.

16. The apparatus as set forth in claim 14, wherein each sub-circuit of the electrical series connection of sub-circuits includes a plurality of SSL devices electrically connected in series.

17. The apparatus as set forth in claim 14, wherein each sub-circuit of the electrical series connection of sub-circuits outputs light having a different spectrum from that of the light output by the other sub-circuits of the electrical series connection of sub-circuits.

18. The apparatus as set forth in claim 14, wherein:
the electrical series connection of sub-circuits comprises an electrical series connection of N sub-circuits where N is an integer greater than or equal to two; and
the adjustment current source comprises (N−1) adjustment current sources connected to inject (N−1) electrical currents into respective (N−1) cathode/anode electrical connections of the electrical series connection of N sub-circuits.

19. The apparatus as set forth in claim 14, wherein the SSL devices comprise light emitting diode (LED) devices.
